(19) United States
(12) Patent Application Publication
(10) Pub. No.: US 2015/0181860 A1
(43) Pub. Date: Jul. 2, 2015

(54) TREESTANDS

(71) Applicant: Brian L. Johnson, Hayward, WI (US)

(72) Inventor: Brian L. Johnson, Hayward, WI (US)

(21) Appl. No.: 14/575,218

(22) Filed: Dec. 18, 2014

Related U.S. Application Data
(60) Provisional application No. 61/921,762, filed on Dec. 30, 2013.

(51) Int. Cl. A01M 31/02

(52) U.S. Cl. CPC A01M 31/02

(57) ABSTRACT

Treestands with seating arrangements that enable a hunter or hunters to face in different directions. Various locking arrangements for preventing unauthorized access to the treestands are also disclosed.

### CROSS-REFERENCE TO RELATED APPLICATION

This non-provisional patent application claims the benefit of and priority under 35 U.S.C. §119(e) from U.S. Provisional Patent Application Ser. No. 61/921,762, filed Dec. 30, 2013, entitled “TREESTANDS”, the entire disclosure of which is herein incorporated by reference.

### FIELD OF THE INVENTION

Various forms relate to treestands used primarily for hunting and more particularly, to treestands that enable a hunter or hunters to face in multiple directions.

### BACKGROUND

Over the years, a variety of different treestands have been designed which afford a hunter the ability to hunt and shoot from an elevated platform. Such approach places the hunter above the animal's line of sight and also helps to prevent the hunter's scent from being detected by the animal. Prior treestand arrangements, particularly those that include a ladder, employ seat arrangements that require the hunter to place his or her back to the tree. Such arrangements fail to take full advantage of the tree in order to remain undetected by the hunted animal.

Various embodiments disclosed herein may address one or more of the needs identified above and others. The foregoing discussion is intended only to illustrate some of the shortcomings present in the field of the invention at the time, and should not be taken as a disavowal of claim scope.

### BRIEF DESCRIPTION OF THE FIGURES

The accompanying drawings, which are incorporated in and constitute a part of this specification, illustrate embodiments, and, together with the general description given above, and the detailed description given below, serve to explain the principles of the various forms and embodiments disclosed herein.

FIG. 1 is a front elevational view of a portion of a treestand implementation;

FIG. 2 is a top view of the treestand of FIG. 1 relative to a tree with the rear platform segment, the front seat and the rear seat pivoted to their respective up positions;

FIG. 3 is another top view of the treestand of FIGS. 1 and 2 with the rear platform segment, the rear seat and the front seat pivoted to their respective down positions;

FIG. 4 is a right side elevational view of the treestand of FIGS. 1-3 with the rear platform segment pivoted up and the front and rear seats pivoted up;

FIG. 5 is another right side elevational view of the treestand of FIGS. 1-4 with the rear platform segment in the down position and the front and rear seats shown in multiple positions;

FIG. 6 is a bottom view of a front seat of the treestand of FIGS. 1-5;

FIG. 7 is a side perspective view of the front seat of FIG. 6;

FIG. 8 is a front view of the front seat of FIGS. 6 and 7;

FIG. 9 is a top view of the treestand implementation of FIGS. 1-5 relative to a tree;

FIG. 10 is a side view of the treestand of FIGS. 1-5 illustrating a person sleeping on the treestand floor;

FIG. 11 is a top view of the treestand of FIG. 10;

FIG. 12 is a rear perspective view of another treestand implementation with rear seat in a locked position to prevent access to the treestand from the ladder and with the front seat positioned in an up position;

FIG. 13 is another rear perspective view of the treestand of FIG. 12 with the front seat pivoted to an up position and the rear seat in a down position;

FIG. 14 is another rear perspective view of the treestand of FIGS. 12 and 13 with the rear seat moved to a central position;

FIG. 15 is another rear perspective view of the treestand of FIGS. 12-14 wherein the front seat has been attached to the frame in the rear seat position and the rear seat has been attached to the frame in the front seat position;

FIG. 16 is another rear perspective view of the treestand of FIG. 15 wherein the rear seat is down and the front seat is pivoted up to enable it to function as a gun rest;

FIG. 17 is a rear perspective view of another treestand implementation that employs a single seat that is attached in a front seat position and is pivoted in an up position;

FIG. 18 is another rear perspective view of the treestand of FIG. 17 with the seat thereof pivoted in a down position;

FIG. 19 is another rear perspective view of the treestand of FIGS. 17 and 18 with the seat attached in a rear seat position and pivoted in an up position;

FIG. 20 is another rear perspective view of the treestand of FIGS. 17-19 with the seat attached in the rear seat position and pivoted down;

FIG. 21 illustrates an adjustable treestand brace arrangement attaching a portion of a treestand to a tree;

FIG. 22 is a perspective view of a treestand brace arrangement;

FIG. 23 is a side cross-sectional view of a double tooth plate tree brace arrangement;

FIG. 24 is a perspective view of a locking mechanism embodiment;

FIG. 25 is a perspective view of a latching portion of the locking mechanism of FIG. 24; and

FIG. 26 is a perspective view of the locking mechanism of FIGS. 24 and 25 attached to a portion of a treestand.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments and that the scope of the various embodiments is defined solely by the claims. The features illustrated or described in connection with one exemplary embodiment may be combined with the features of other embodiments. Such modifications and variations are intended to be included within the scope of the present invention.

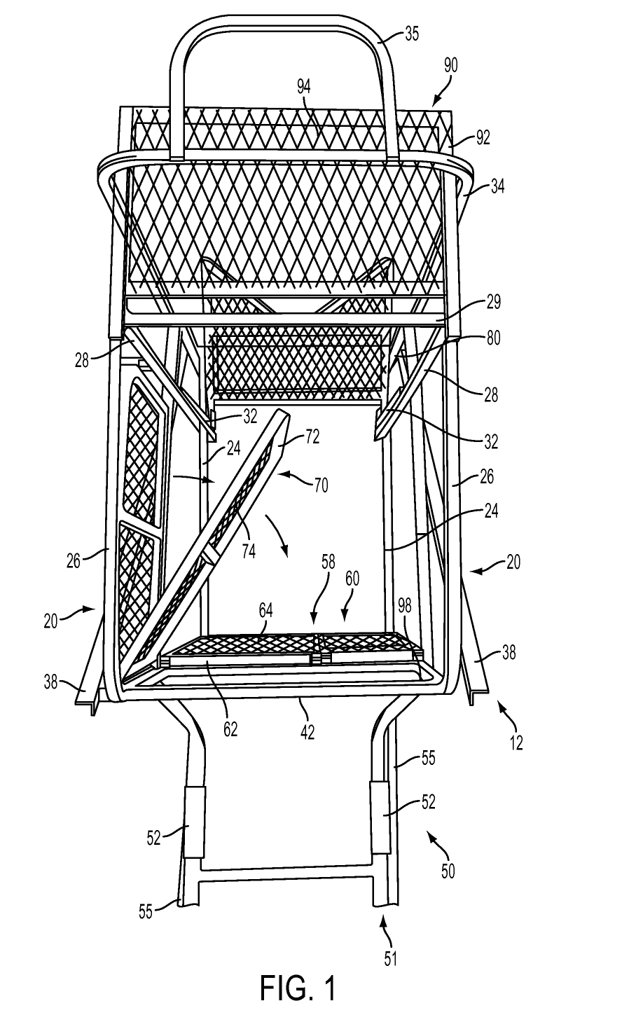

Referring to FIGS. 1-5, there is shown a treestand 10 that provides several unique and novel advantages. For example, in at least one arrangement, the treestand 10 affords a hunter or “occupant” the option of sitting down while facing the tree or facing away from the tree to which the treestand is attached. As can be seen in FIGS. 1-5, the treestand 10 shown in those Figures includes a frame 12 that is fabricated from metal such as steel or other suitable material that affords sufficient strength to support one or two hunters or occupants above the ground. In at least one implementation, the frame 12 includes two side members 20 that each has a bottom strut portion 22 and an upstanding front strut portion 24 and an upstanding rear strut portion 26. As used herein, the term “front” will refer to the portion of the treestand that, when the treestand is attached to a tree, is closest to the tree. The illustrated frame 12 further includes two intermediate side struts 28 that extend between corresponding upstanding front and rear struts 24, 26 and may be welded thereto or attached thereto by suitable fasteners such as bolts, for example. In addition, a rear cross-strut 29 is welded or otherwise attached between the rear struts 26 as can be most particularly seen in FIG. 1. Two additional side rails 30 may be attached to a corresponding front strut 24, intermediate strut 28 and bottom strut 22 as shown. A reinforcing strut 32 may be attached to a corresponding front strut 22 and side strut 28 as shown. A U-shaped top strut 34 may be attached to the side rails 30 and include downwardly extending brace portions 36 that are attached to the rear struts 26. An angle strut 38 may be attached to a corresponding side rail 30 and bottom strut 22 as shown. The frame 12 further includes a front cross strut (not shown) and a rear cross-strut 42.

The frame 12 is configured to be attached to a ladder assembly 50. In at least one implementation, the ladder assembly 50 may include ladder segments that are fabricated from metal tubing that may be attached together in end-to-end fashion. For example, the metal tubing may have a square cross-sectional shape. As can be seen in FIG. 1, for example, bottom ladder mounting struts 54 are attached to the frame 12. Each ladder strut 54 has a socket 52 attached thereto for receiving a corresponding portion of a ladder segment 51 therein. The height that the treestand 10 is placed in the tree may be largely dependent upon how many ladder segments are attached together in end-to-end fashion. Additional reinforcing struts 55 may be attached between the bottom struts 22 and the corresponding ladder strut 54 or ladder segment 51 as shown.

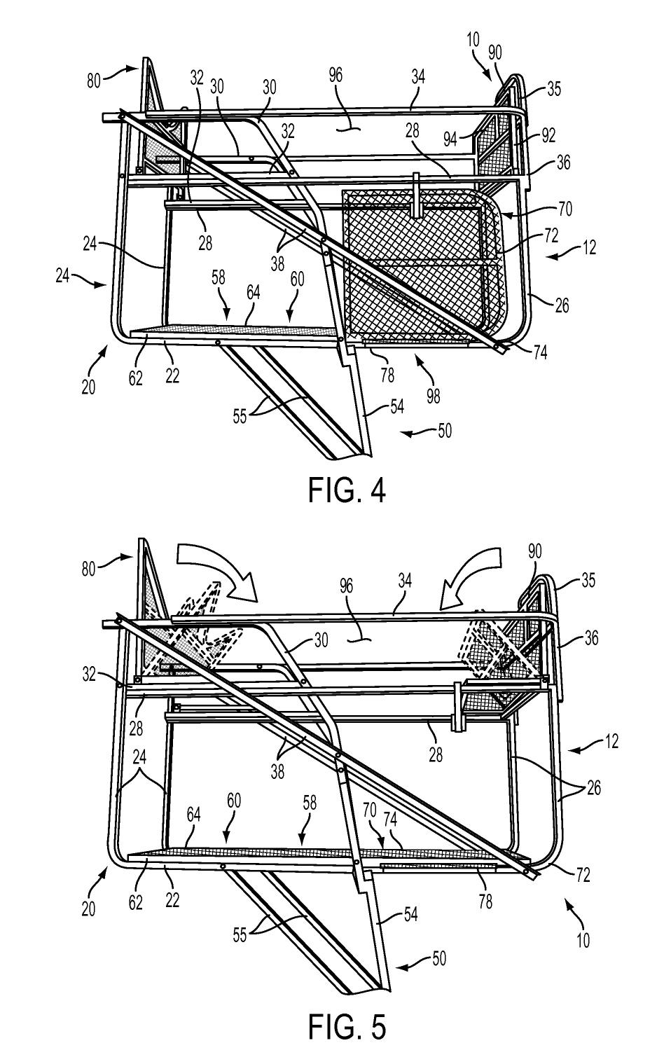

In the embodiment of FIGS. 1-5, the treestand includes a platform assembly 58 that includes a front platform segment 60 and a rear platform segment 70. The front platform segment 60 includes a front frame portion 62 that has a section of expanded metal 64 attached thereto. Similarly, the rear platform segment 70 has a rear frame 72 that has expanded metal 74 attached thereto. As can be seen in FIG. 4, the rear platform segment 70 may be pivotally attached to one of the bottom struts 22 by a piano hinge 78 that enables the rear platform segment 70 to pivot between a first down position (FIGS. 3 and 5) and an up position (FIGS. 1 and 4).

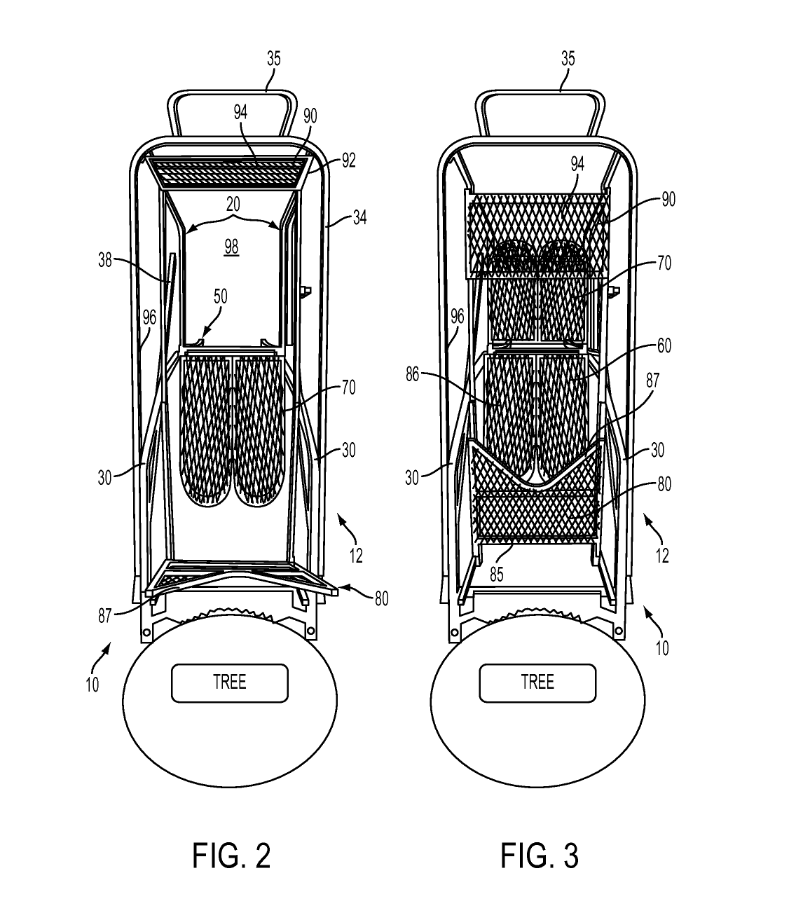

As can be seen in FIGS. 2-5, the frame 12 defines an “occupancy area” or “occupancy envelope” generally designated as 96. The occupancy area 96 includes the area in which an occupant or hunter may move around on the treestand. One unique and novel feature of the treestand 10 is that the occupancy area 96 is also defined by the intermediate struts 28 and the U-shaped top strut 34 which are all located above the platform assembly 58 and serve to provide side structure that may guard against the occupant from stepping off the platform assembly 58. Thus, the occupant or hunter may lean against these structures while preparing to take a shot without risk of stepping or falling off the platform assembly 58. In the illustrated arrangement, the ladder assembly 50 is attached to the frame 12 between the front strut portions 24 and the rear strut portions 26 such that the occupant or hunter would enter an open area or entry opening, generally designated as 98, that is located between the bottom strut portions 22, the front platform segment 60 and the rear cross strut 42. See FIG. 1. When the rear platform segment 70 is in the down (first) position, the rear platform segment 70 covers or is located over the open area 98. Thus, when the rear platform segment 70 is down, the occupant or hunter is unable to enter the treestand through the entry opening 98. In order for a hunter or occupant to gain access to the treestand, the rear platform segment 70 must be pivoted to the up position (FIGS. 1 and 4) to enable the hunter or occupant climbing up the ladder 50 to enter the treestand between the side members 20. Once in the treestand and while standing on the front platform segment 60, the hunter or occupant may pivot the rear platform segment 70 down to create an expanded platform assembly 58 wherein the rear platform segment 70 is coplanar with the front platform segment 60.

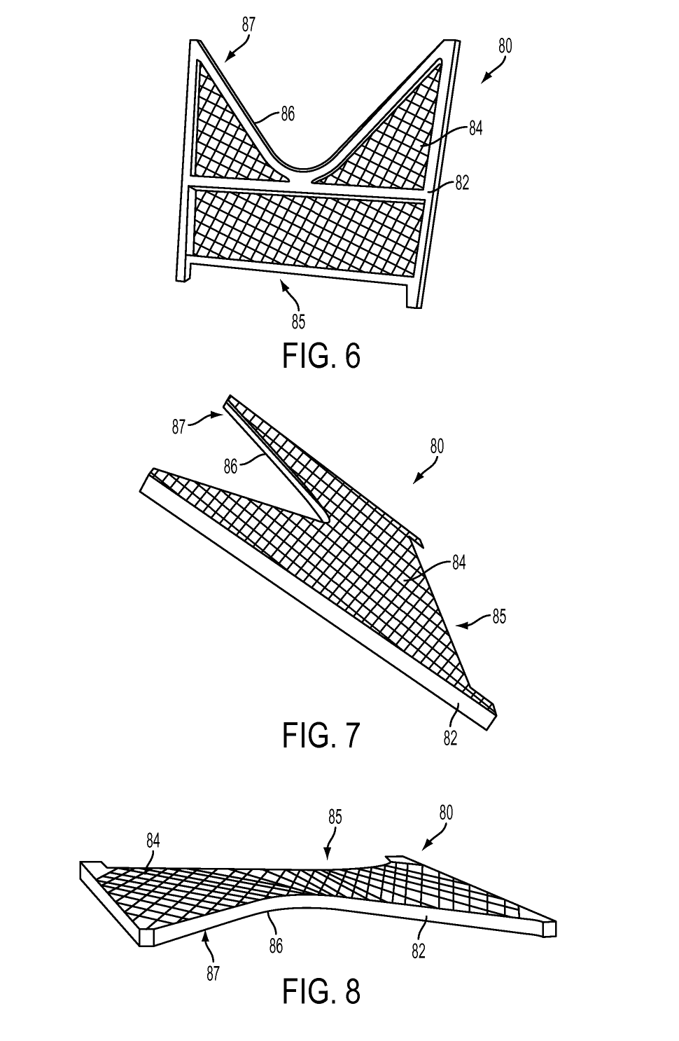

The treestand 10 may further include a front seat 80 and a rear seat 90. The front seat 80 may include a frame 82 that has expanded metal 84 attached thereto. The frame 82 may be pivotally coupled to the struts 32 to enable it to pivot between an up position (FIGS. 1, 2, 4 and 5) and a down position (FIG. 3). In the illustrated arrangement, the front seat 80 includes a font-facing front end 83 that faces the tree and a rear-facing rear end 87 that faces away from the tree. In the illustrated embodiment, a notch 87 is formed in the rear end 86 to provide the hunter with additional maneuverability in the stand. See FIGS. 6-8. In the illustrated arrangement, the notch 87 has V-shape. The rear seat 90 may include a frame 92 that has expanded metal 94 thereon. The frame 92 may be pivotally attached to the frame assembly 12 such that it may be pivoted between and up position (FIGS. 1, 2, 4 and 5) and a down position (FIG. 3.). To provide the occupant with back support while seated in the rear seat 90, an upstanding back support strut 35 is attached to the top strut 34 as shown.

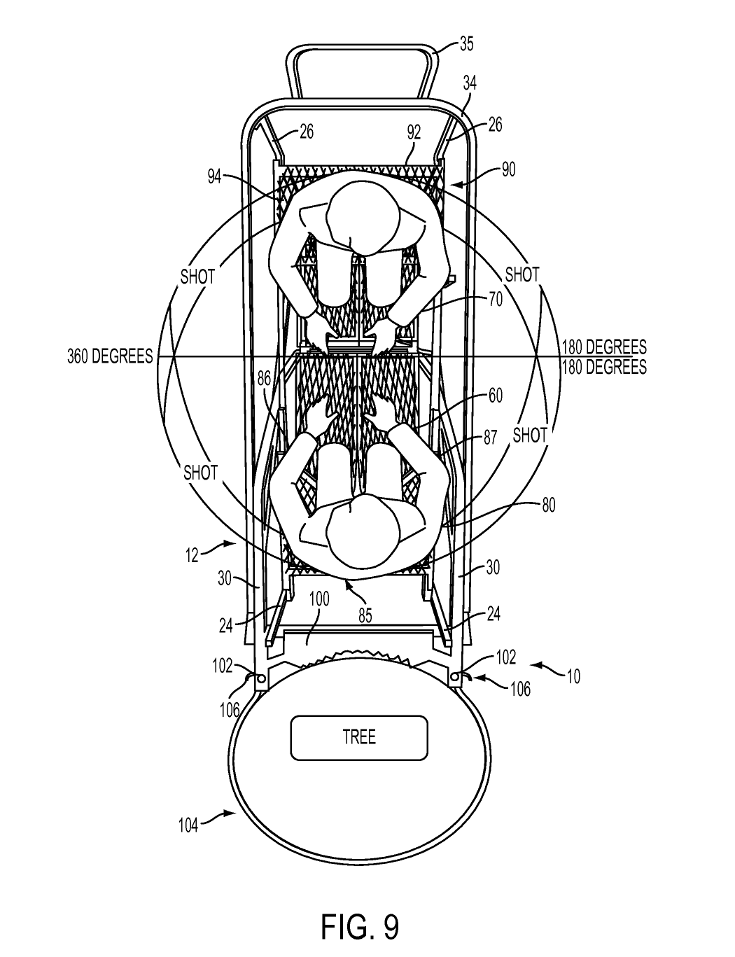

Referring to FIG. 9, the side members 30 may be equipped with a tooth plate structure 100 that is attached thereto and configured to dig into the tree. A pair of holes 102 is provided to enable hooks 106 on a ratchet strap 104 to be hooked therethrough to attach the treestand 10 to the tree.

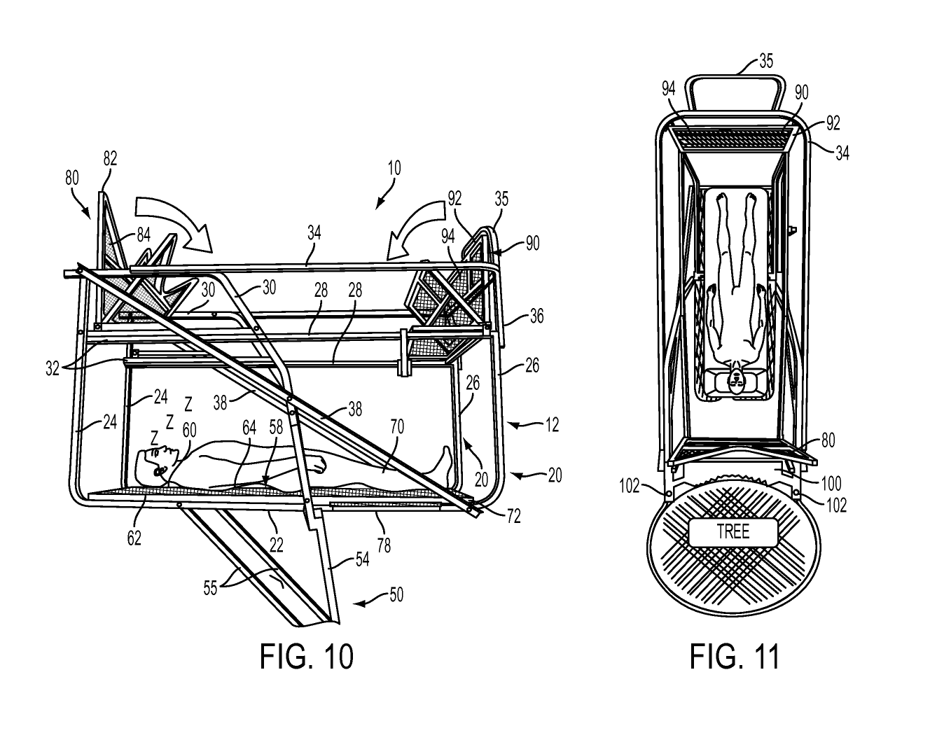

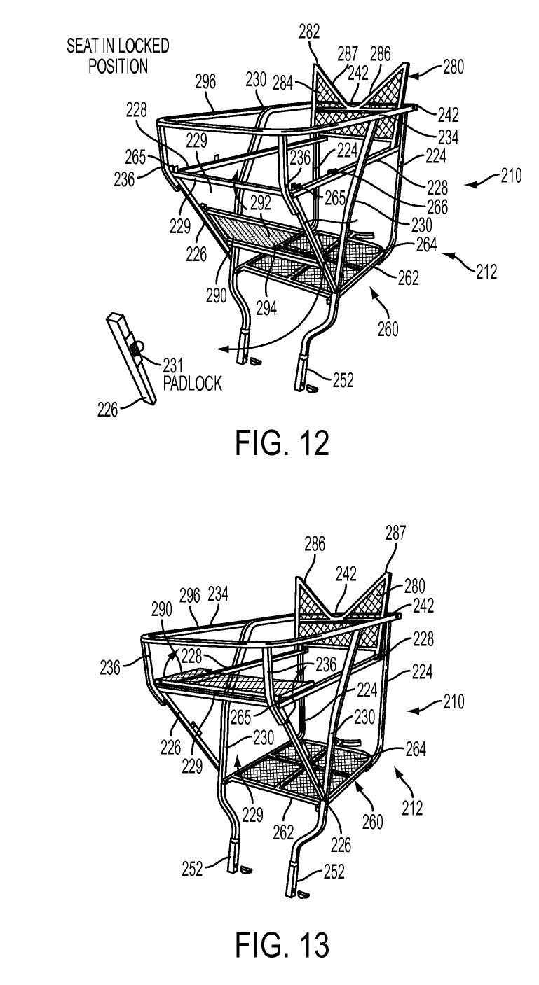

The treestand 10 of FIGS. 1-5 and 9-11 may be capable of accommodating two hunters at a time. FIGS. 12-16 illustrate a similar treestand 210 that may be sized to only accommodate one hunter. As can be seen in FIGS. 12-16, the treestand 210 includes a frame assembly 212 that is fabricated from metal such as steel or other suitable material that affords sufficient strength to support a hunter or occupant above the ground. In at least one implementation, the frame assembly 212 includes two front members 224 that are attached to a platform 260. The platform 260 may include a platform frame 262 that has expanded metal grate 264 attached thereto. As used herein, the term “front” will refer to the portion of the treestand that, when the treestand is attached to a tree, is closest to the tree. The illustrated frame assembly 212 further includes two side struts 230 that are also attached to the platform 260. Each side strut 230 extends down below the platform 260 and includes a socket 252 that is configured to receive portions of a ladder assembly 260 therein. Two intermediate side struts 228 are attached to the front struts 224 and the side struts 230 and are attached to corresponding rear struts 226 as shown. The struts may be attached together by suitable fasteners such as bolts, clips, etc. or they may be welded together, for example. In addition a rear cross-strut 229 is welded or otherwise attached between the rear struts 226. A U-shaped top strut 234 may be attached to the side rails 30 and include downwardly extending rear brace portions 236 that are attached to the rear struts 226 and rear cross-strut 229. The frame assembly 212 further includes a front cross strut 242.

The frame assembly 212 is configured to be attached to a ladder assembly. In at least one implementation, the ladder assembly may include ladder segments that are fabricated from metal tubing that may be attached together in end-to-end fashion. For example, the metal tubing may have a square cross-sectional shape and be configured to be slidably inserted into the sockets 252. The height that the treestand 210 is placed in the tree may be largely dependent upon how many ladder segments are attached together in end-to-end fashion.

As can be seen in FIGS. 12-15, the frame 212 defines an “occupancy area” or “occupancy envelope” generally designated as 296. The occupancy area 296 includes the area in which an occupant or hunter may move around on the treestand. One unique and novel feature of the treestand 210 is that the occupancy area 296 is also defined by the intermediate struts 228 and the U-shaped top strut 234 which are all located above the platform assembly 260 and serve to provide side structure that may serve to guard against the occupant from stepping off the platform 260. Thus, the occupant or hunter may lean against these structures while preparing to take a shot without risk of stepping or falling off the platform 260. To enter the treestand 210 from the ladder assembly, the occupant or hunter must enter through the opening 298 defined between the rear edge of the platform 260, the two rear struts 226 and the rear cross-strut 229.

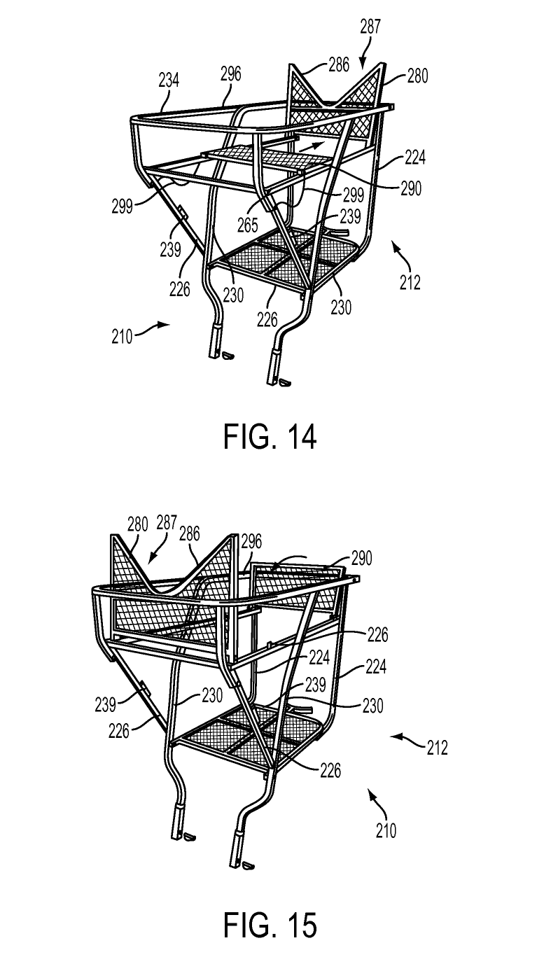

The treestand 210 may further include a front seat 280 and a rear seat 290. The front seat 280 may include a frame 282 that has expanded metal 284 attached thereto. The frame 282 may be pivotally coupled to the struts 228 to enable it to pivot between an up position (FIGS. 12-15) and a down position wherein the front seat 280 is essentially parallel to the platform 260. In the illustrated arrangement, the front seat 280 includes a font facing end 285 and a rear-facing end 286. In the illustrated embodiment, a notch 287 is formed in the rear-facing end 286 therein to provide the hunter with additional maneuverability in the stand. In the illustrated arrangement, the notch 287 has V-shape. The rear seat 290 may include a frame 292 that has expanded metal 294 thereon. The frame 292 may be movably attached to the frame assembly 212 in a first position wherein the occupant may be seated thereon to face the tree. See FIG. 13. The frame 292 may be pinned to rear attachment tabs 265 on the struts 228. The rear seat frame 292 may be removably attached to the rear attachment tabs 265 by conventional pin clips (not shown). In addition, the rear seat 290 may be attached to or tethered to the frame 212 by cables 299. When the rear seat frame 292 is pinned to the rear attachment tabs 265, the rear seat 290 may be pivoted to an up position as illustrated in FIG. 15. In addition, the rear seat 290 may be attached to the central attachment tabs 266 on struts 228 in the intermediate position illustrated in FIG. 14. In particular, the rear seat frame 292 may be pinned to the central attachment tabs 266 on the struts 228. To prevent unauthorized access to the treestand 210, the rear seat 290 may be attached to the rear struts 226 so as to block the entry opening 229 as shown in FIG. 12. The rear seat frame 292 may be locked to the rear struts 226 by one or more pad locks 231 that affix the rear seat frame 292 to lock tabs 239 on the rear struts 226.

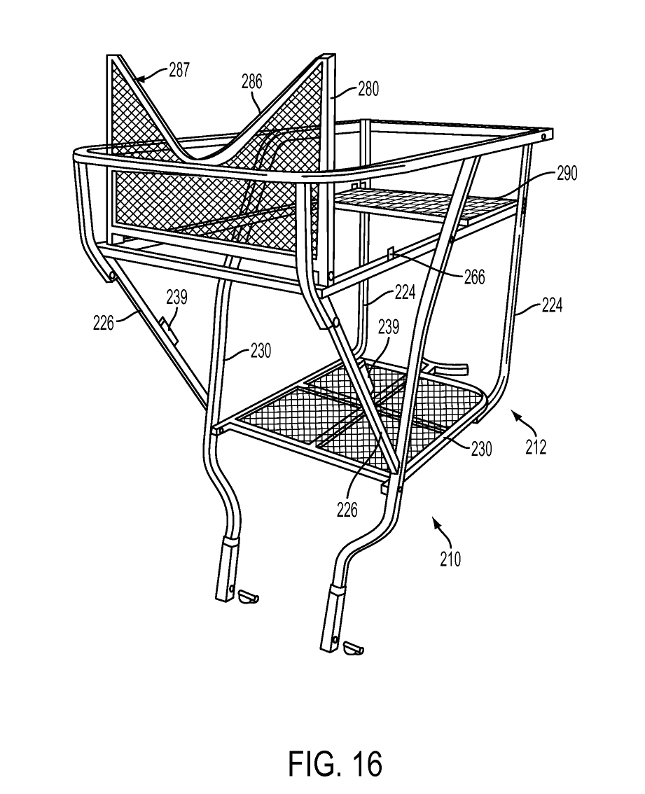

In at least one arrangement, the positions of the front seat 280 and the rear seat 290 may be interchanged. For example, FIGS. 15 and 16 illustrate the rear seat 290 in the front seat position (i.e., closest to the tree) and the front seat 280 in the rear seat position. When the rear seat 290 is located in front seat position the hunter may be seated thereon facing away from the tree to which the treestand is attached. The hunter may pivot the front seat 280 to an up position as illustrated in that FIG. 16 so as to provide a steady rest for the hunter's gun. The bottom of the V-shaped notch 287 provides a convenient cradle for supporting a portion of the gun thereon.

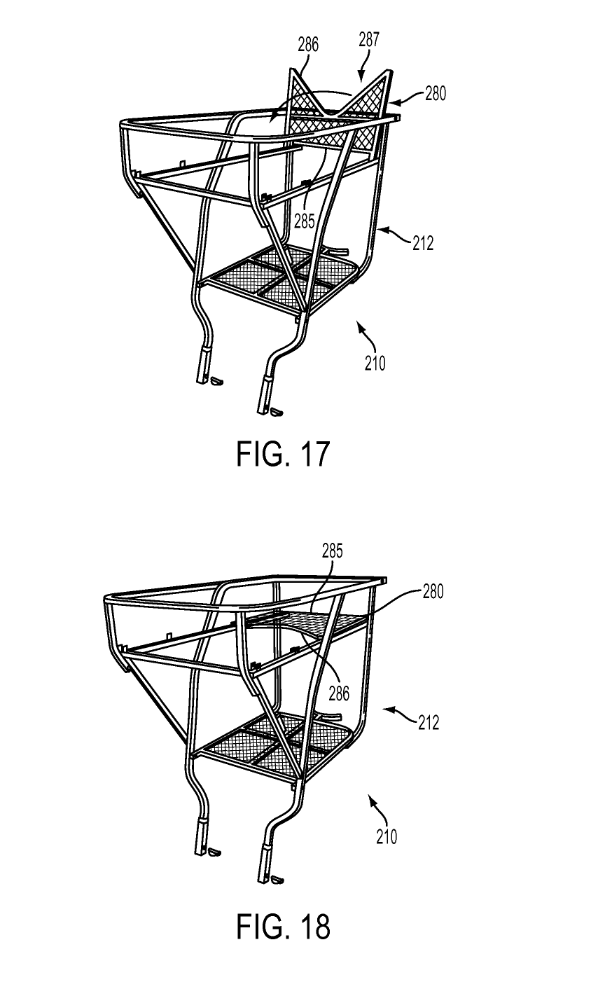

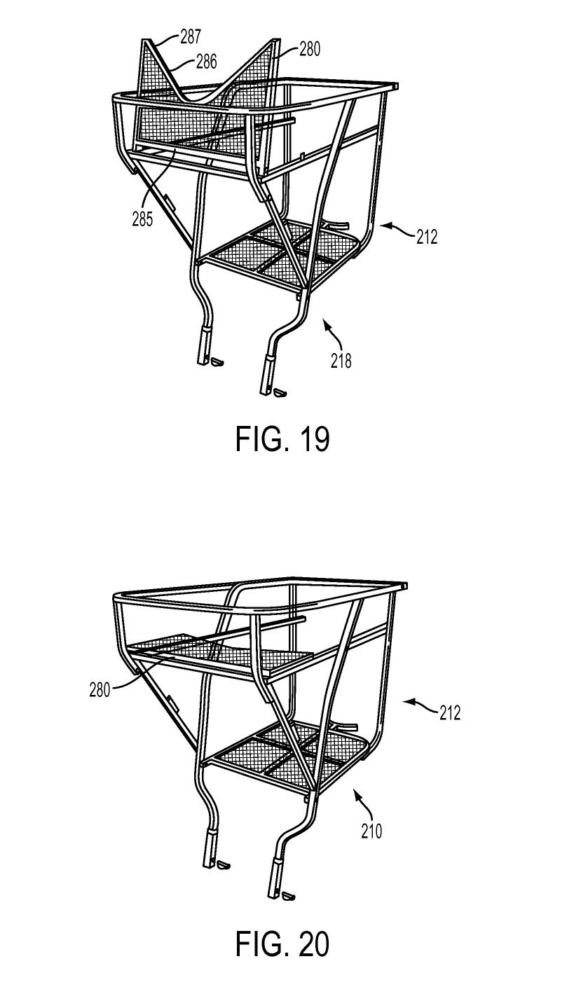

FIGS. 17-20 illustrate use of the treestand 210 with only the front seat 280. For example, FIG. 17 illustrates the front seat 280 attached in the front position and pivoted to an up position. FIG. 18 illustrates the front seat pivoted to its down position such that when the hunter occupant sits on the seat 280, he or she faces a way from the tree to which the treestand 210 is attached. In FIG. 19, the front seat 280 has been attached to treestand 210 in the rear position and is pivoted to an up position. In FIG. 20, the front seat 280 is in the rear position and pivoted down such that when the hunter occupant sits on the seat, he or she is facing the tree to which the treestand is attached.

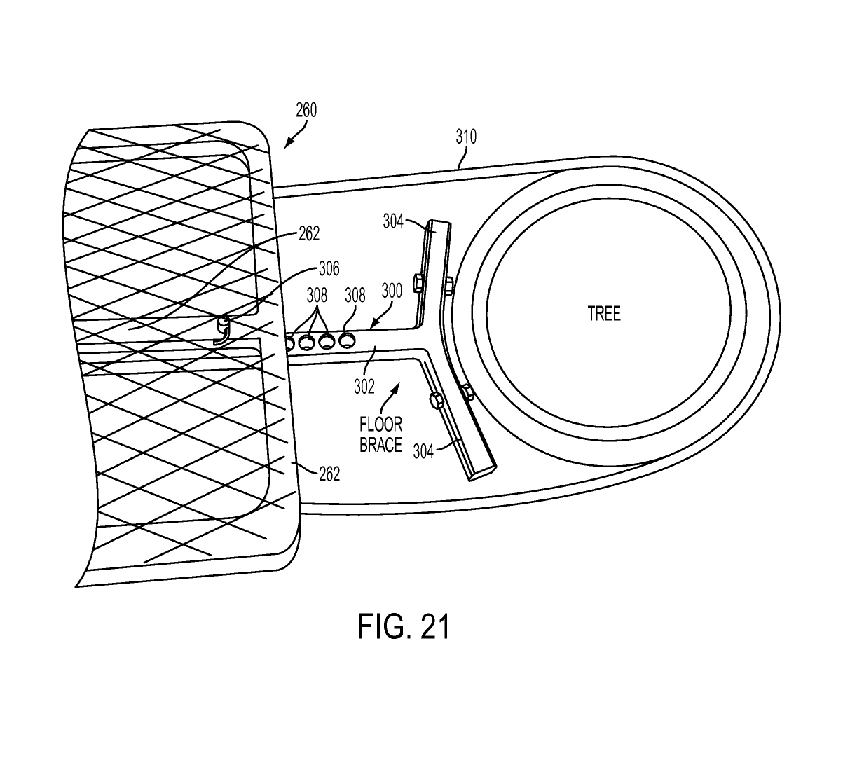

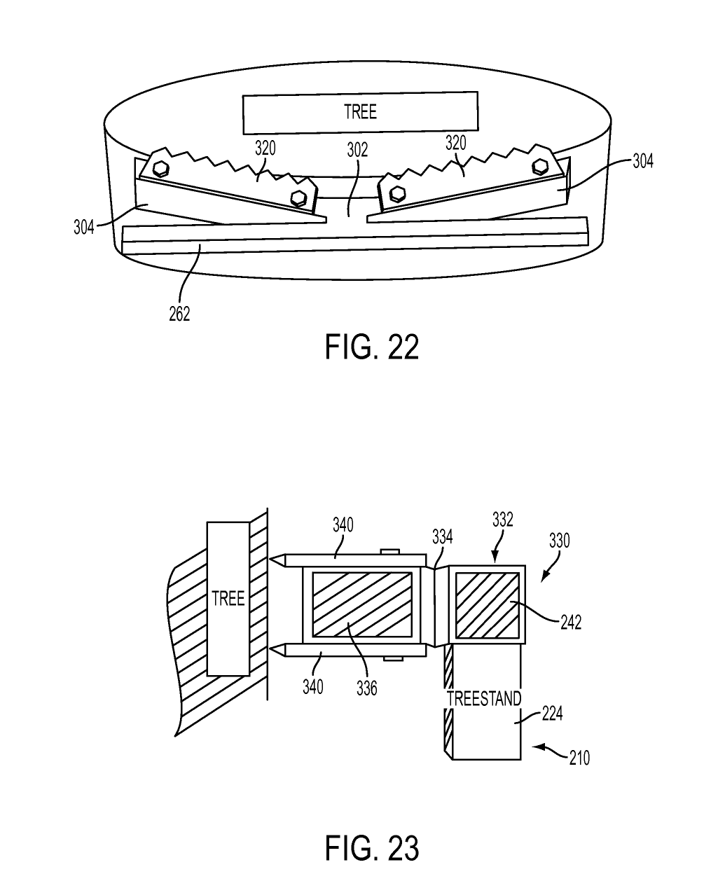

FIG. 21 illustrates a detachable and adjustable tree brace 300 that may be attached to the platform 260 of the treestand 210. As can be seen in that Figure, the tree brace 300 may have a central brace portion 302 and a transverse brace portion 304 such that the brace 300 somewhat resembles a “T”. A series of holes 308 may be provided through the central brace portion 302 to enable the tree brace 300 to be attached to the platform 260 in a plurality of predetermined locations by a fastener 306 such as a pin, bolt, etc. Such arrangement enables the transverse brace portion 304 that abuts the tree to be located at varying distances from the platform. See FIG. 21. The treestand 210 may be attached to the tree by an endless member 310 such as a ratchet-type strap arrangement that has hooks (not shown) attached to each end of the strap. The hooks may be hooked over a portion of the platform frame 262 and the strap wrapped around the tree so that the user can ratchet the platform 260 towards the tree. As the platform 260 is ratcheted towards the tree, the tree brace 300 engages the tree as shown to provide further stability to the treestand 210. In the embodiment depicted in FIG. 22, the central brace 302 is attached to or is integral with the platform frame 262. In such arrangement, the distance between end of the platform and the tree cannot be adjusted by the brace. To assist the transverse brace portions in non-movably engaging the tree, toothed plates 320 may be attached to the transverse brace portions 304 as shown in FIG. 22. These plates 320 may also be attached to the tree brace 300 illustrated in FIG. 21.

FIG. 23 illustrates an alternative tree brace 330 that may be used in connection with any of the various tree stand arrangements disclosed herein. FIG. 23 illustrates use of the tree brace 330 in connection with a tree stand 210. As can be seen in that Figure, the tree brace 330 includes a socket or mounting portion 332 that may be slid onto or otherwise mounted to the front cross-strut 242 of the treestand 210. The tree brace 330 further has a central portion 334 and two transverse brace portions 336. A pair of toothed plates 340 may be attached to each of the transverse brace portions 336.

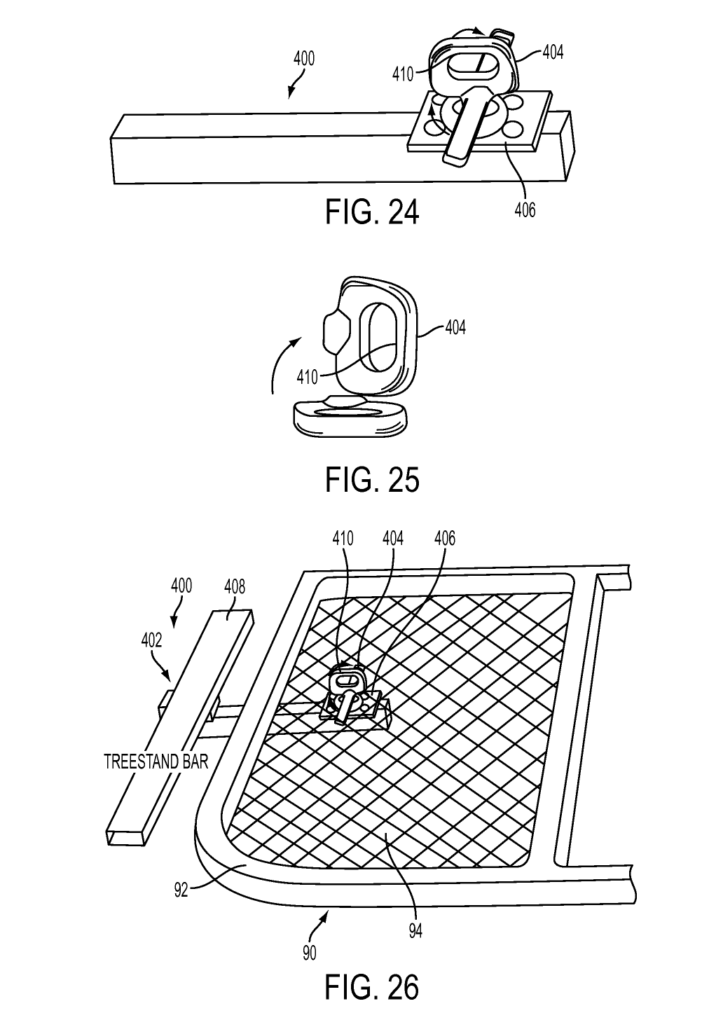

FIGS. 24-26 illustrate a unique and novel pad lock arrangement 400 for locking the rear platform segment in a down position. The padlock arrangement 400 may include a T-shaped lock bar 402 that has a detachable lock member 404 attached thereto. When in one position, the detachable lock member 404 is non-removably attached to a corresponding mounting portion 406 of the bar 402. When in another rotated position, lock member 404 can be detached from to the mounting portion 406. The lock member 404 has a hole 410 therethrough for receiving a conventional lock (not shown). When the lock is attached to the lock member 404, the lock member 404 cannot be detached from the mounting portion 406. To use the padlock arrangement 400, the user pivots the rear platform segment 90 to its down position. The lock bar 402 is placed under the frame assembly 12 such that the T-portion 408 is in contact with the frame 12. The lock member 404 is placed over the expanded metal 94 and brought into mounting engagement with the mounting portion 406 located under the expanded metal 94. A conventional lock is attached to the lock member 402 to prevent its detachment. While the padlock arrangement 400 is attached to the rear platform segment 90, the rear platform segment 90 is unable to pivot to an open position whereby someone could gain access to the treestand.

When hunting big game from treestands, a hunter tries to remain camouflaged as much as possible to avoid detection by the quarry animal. For example, wild game (specifically whitetail deer) has excellent eyesight and is not easily fooled by camouflage patterns which tend to show the silhouette of the hunter's shape. One method that is typically employed to avoid detection by a deer, for example, is to climb dangerously high in a tree above the deer's vertical eyesight plane. Such method, however, can reduce the effective kill zone of the animal due to the steep trajectory angle of the bullet or arrow. In other words, the higher in the tree, the smaller the “effective target area” gets. As used herein, the term “effective target area” refers to that area on the animal where if struck by an arrow or bullet will most likely result in a quick kill. Conversely, the lower in the tree that the hunter shoots, the bigger the effective target area becomes. However, the hunter has a greater chance of being visually detected by the deer. The various treestands disclose herein provide solutions to at least some of these challenges. For example, at least some of the treestands disclosed herein enable the hunter to place the treestand in the tree so that the tree acts as camouflage between the hunter and the deer. Previously, the hunter would have to stand and turn around to use the tree to his or her advantage for camouflage. Obviously, standing for a long period at time may be tiring and uncomfortable and thus may be rarely employed. When using at least some of the treestands disclosed herein, the hunter can sit and face the tree while being hidden from the deer and also be able to hunt lower in the tree which may be safer and afford the hunter with a larger effective target area.

Another advantage provided by at least some of the treestands disclosed herein is that the hunter can shoot to his or her right and left while remaining seated in the treestand. In many prior treestand implementations, the hunter in a forward facing, single seat treestand can only shoot sitting down to his or her left (right handed hunter) with a maximum 180 degree angle from the front to the back while pivoting on the forward facing seat. Many hunters prefer to shoot sitting down as opposed to standing because they tend to shoot more accurately because they are more stable sitting than standing. However, if the deer appears on the opposite side of the tree from which the hunter is facing, the hunter usually has difficulty shooting at the deer or is unable to shoot at the deer entirely. When using those treestands disclose herein that employ two seats, this challenge is avoided because the hunter can simply move to the seat that is facing in proper direction. Various treestands disclosed herein that employ two seats, allow a full 360 degree of shooting angles which is a vast improvement over prior treestand designs.

In various treestand implementations disclosed herein, the seats can be positioned in a number of positions. For example, one seating arrangement is with one primary (front) seat against the tree and the secondary (rear) seat facing the tree. If the hunter chooses to face the tree only and wants to sit closer to the tree, he or she can simply move the secondary (rear) seat forward in the pre-positioned attachment tabs and remove the primary (front) seat so his or her legs can get closer to the tree. Also, in various implementations, these adjustments may allow enough space in the stand for the hunter to lie down. He or she can then take the primary (front) seat and place it in a camouflage slot behind the secondary (rear) seat. This allows the primary (front) seat to function as a camouflage foliage support screw. That is, the hunter may insert small branches that still contain leaves or artificial foliage into the expanded metal portion of the seat to further conceal the treestand.

In addition, if the hunter chooses to sit on the primary (front) seat, he or she can detach the secondary (rear) seat out from the attachment tabs and place it in the camouflage bracket (i.e., tabs or brackets attached to the frame that are configured to support the seat in such a manner so as to receive and support small branches and/or artificial foliage). Tree branches (foliage, real or artificial) may be placed into the seat and/or in the camouflage brackets along with the placing foliage in bungee straps which may also be attached to the primary (front) tree seat. This acts as a tree blind camouflaging the hunter from his quarry. Fourth, when the secondary (rear) seat is in the camouflage bracket (i.e., tabs or brackets attached to the frame that are configured to support the seat in such a manner so as to receive and support small branches), the front of the seat sets vertically upward and acts as a shooting rest for the gun hunter to steady his gun while shooting. Another feature of the secondary seat is that it can be used as locking device when locking in the camouflage brackets.

When climbing into the stand, the rear seat may be pivoted to the up position to permit the hunter to enter the stand. Once the hunter has climbed onto the stand, he or she can simply with one hand reach down and pivot the rear seat down and onto the frame assembly. He or she can now sit on the rear seat. When leaving the stand, the hunter can simply with one hand pivot the rear seat back into the vertical position against the back rest rails.

If the hunter wants to utilize the rear seat as either a support for camouflage material (real and/or artificial branch segments, foliage, etc.) or as a shooting rail/gun support, he or she can simply slide the seat forward toward the tree which will disengage the seat from the treestand. The seat may then be placed in the “camoblind” brackets. The brackets may be designed to support the seat in a somewhat vertical position such that no pin or attaching fasteners are needed. The seat can then be set into the “camoblind” bracket which holds the seat in a slight lean forward (away from tree) position. If used as camouflage, blind branches can be placed into additional branch brackets that may be welded or otherwise attached to the outside of the seat. Bungee straps can also be strapped to the seat allowing additional branches (camouflage, real or artificial) to be functionally fitted between the stand and the seat.

Now that I had solved the problem of how to enter the treestand by pivoting the seat up and out of the way, I discovered another obstacle that needed to be overcome. Here's the obstacle, the two opposing tree seats could only be separated a given distance. The reason is quite simple. The treestand platform has to be under the hunter's feet when he/she is sitting on either seat. When I placed the secondary seat the proper distance from the primary seat, my knees were tight up against the other seat. Also, when I stood and turned sideways facing the front of the treestand, my feet were forced to be partially off the treestand. This was and is a problem that I have had with all ladder stands. This is not only uncomfortable but it is dangerous because you could fall out of the treestand.

I discovered that the solution to my problem of the seat having to be too close together would also solve the dangerous problem of turning and having your feet being forced off the treestand. The unique and novel shape of the front seat helps to solve this problem. As can be seen in various Figures herein, at least one version of the front seat has a concave shape that is V-shaped or somewhat “C”-shaped in the middle but is the same width at the front corners. Now when the hunter stands and turns his or her legs, he or she can pivot their legs into the concave “C” shape with six inches more leg room. With this design, the hunter's feet will not come off the treestand platform when he or she turns sideways. This represents a vast improvement over prior treestand arrangements that require the hunter to be farther from the tree which increases the likelihood of being spotted by the game and can also result in greater leverage being placed on the stand.

The “two person” treestand may employ heavier materials that are capable of safely supporting two people. Such arrangement enables one person to visually scan 180 degrees of hunting area and the other person to scan the other 180 degrees to ensure that all 360 degrees around the treestand is monitored. Present side by side two person treestands only allow both hunters to visually watch only the same 180 degrees of cover leaving the other 50 percent unwatched which would allow game to walk by undetected.

In addition, various treestand arrangements disclosed herein may include a cushion that covers the concave front profile of the tree seat by bridging the gap since the metal frame of the front corner of the tree seat protrudes out the standard distance which supports the cushion. When the hunter stands and turns, the cushions may be attached with straps to the rear of the seat to enable the front of the cushion to pivot in the upward direction. Such arrangement allows the hunter to sit down with the full cushion support and also stand and turn with additional leg room.

Various treestand implementations disclosed herein may also include an optional back support rail. As the name implies, the secondary seat occupant can lean back on a cushioned back rest which is supported by brackets and a back support rail that is attached to the treestand. Additional support may also be advantageous on the vertical support ladder rails. The back support rail may also act as a support for camouflage materials (real and artificial). In addition, tree branch loops may be welded to the back support rail so that natural and artificial camouflage branches can be inserted in the loops to help hide the hunter. The “loops” can be made out of metal, bungee chords, Velcro®, or similar strapping material. Commercially purchased camouflage fabric can also be attached to the back support rail with the above mentioned fasteners.

To facilitate entry to two people into the two person stand, the floor and seat for the second person (the person that sits our farthest from the tree) can be pivoted up and out of the way. The horizontal floor can then be pivoted back down into the floor position after entering the stand. Once both hunters are in the stand and the floor is down, it is unlikely that either hunter's feet come off the end of the stand.

Most if not all, prior treestand arrangements that can support two people are designed such that the two hunters must sit side-by-side thereby limiting the shooting ability of both hunters. Each hunter can only shoot their perspective directions. The hunter on the right can only shoot to the right and the hunter on the left can only shoot to the left. This is because their weapons would cross over in front of the each other which may be dangerously unsafe. Various treestand implementations disclosed herein may solve this problem. Because both hunters face each other, they can each shoot to their right and left safely. They also could both simultaneously shoot at the same deer if it was to their right or left.

A fairly common use of two man treestands is for fathers and sons to hunt together. The father typically will want to give his son the first shot. In a typical two man treestand, if the son was on the left and the deer came to the right, only the father could shoot. If the deer came to the left and the son shot and missed which is common for young hunters, the father couldn't shoot safely and the deer would get away. When employing the dual occupancy treestand disclosed herein, if the deer moves to the right or left, the son could shoot first. If the son missed, the father could have his gun aiming at the same deer simultaneously and immediately shoot the deer.

What is claimed is:

1. A treestand, comprising:
a frame having a front portion and a rear portion, the front portion configured for attachment to one side of a tree,
a platform assembly attached to said frame;
a ladder assembly attachable to the frame;
a front seat movably supported on the front portion of the frame above the platform assembly and configured to support an occupant while facing away from the tree; and
a rear seat movably supported on the rear portion of the frame above the platform assembly, the rear seat spaced from said front seat on said one side of the tree and configured to support the occupant while facing the tree.

2. The treestand of claim 1 wherein at least one of said front and rear seats has a V-shaped notch formed therein.

3. The treestand of claim 2 wherein said front seat has a front-facing end that is adjacent to the tree and a rear-facing end that faces away from the tree and wherein said V-shaped notch is in said rear-facing end.

4. The treestand of claim 1 wherein at least one of said front seat and said rear seat is pivotally attached to said frame.

5. The treestand of claim 1 wherein said platform assembly comprises:
a front platform segment non-movably attached to said frame; and
a rear platform segment that is pivotally attached to said frame.

6. The treestand of claim 5 wherein said frame defines an open area located between said front portion and said rear portion of said frame and wherein said ladder assembly is attached to said frame between said front portion and said rear portion such that the occupant enters the treestand through a rear segment of the open area that corresponds to said rear platform segment.

7. The treestand of claim 6 further comprising means for locking the rear platform segment in a down position to block said rear segment of open area to prevent the occupant from entering the treestand through the rear segment of open area.

8. The treestand of claim 1 wherein said frame comprises:
a first side member comprising:
a first bottom strut;
a first upstanding front strut extending from the first bottom strut; and
a first upstanding rear strut extending from the first bottom strut and wherein said frame further comprises:
a second side member comprising:
a second bottom strut;
a second upstanding front strut extending from the second bottom strut; and
a second upstanding rear strut extending from the second bottom strut and wherein said frame further comprises:
a front cross strut attached to said first bottom strut and said second bottom strut and extending therebetween;
a rear cross strut attached to said first bottom strut and said second bottom strut and extending therebetween; and
a side strut attached to said first side member and said second side member and spaced above the first bottom strut and the second bottom strut to define an encircled occupancy area within the frame.

9. The treestand of claim 1 further comprising means for selectively preventing access onto the platform assembly from the ladder assembly.

10. The treestand of claim 1 wherein said frame and platform assembly are sized such that one occupant can be seated on the front seat facing away from the tree while another occupant can be seated on the rear seat facing the tree.

11. The treestand of claim 1 wherein said front portion of said frame comprises a pair of upstanding front vertical struts protruding upward from said platform assembly and wherein said rear portion of said frame comprises a pair of upstanding rear struts protruding upward from the platform assembly to define an entry opening therebetween and wherein said ladder assembly is attached to the frame to permit entry onto the platform from the ladder assembly through the entry opening.

12. The treestand of claim 11 wherein said rear seat is movable from a first occupant supporting position to a second position wherein the rear seat blocks at least a portion of said entry opening.

13. The treestand of claim 12 further comprising means for locking the rear seat in the second position.

14. The treestand of claim 7 wherein said means for locking comprises:
a lock bar; and
a lock member removably attachable to a mounting portion of the lock bar, said lock member configured to receive a lock thereon such that when the lock is attached to the lock member, the lock member cannot be detached from the lock bar.

15. The treestand of claim 14 wherein said rear platform segment comprises expanded metal grating pivotally attached to said frame such that said rear platform segment is pivotal between a down position wherein the rear platform segment is co-planar with the front platform segment and an up position and wherein said lock member includes a portion sized to be inserted through an opening in the expanded metal grating to engage the mounting portion on the lock bar to attach the lock bar to said rear platform segment such that a portion of the lock bar contacts a portion of the frame to prevent the rear platform segment from being pivoted from said down position to said up position.

16. The treestand of claim 1 further comprising a selectively extendable tree brace assembly coupled to said frame and configured to engage the tree.

17. The treestand of claim 16 wherein said selectively extendable tree brace assembly comprises:
a first brace portion configured to be attached to said frame at a plurality of predetermined positions; and
a cross brace portion transversely attached to said first brace portion for engaging a portion of the tree.

18. The treestand of claim 16 wherein said tree brace assembly comprises:
a first pair of spaced toothed plates; and
a second pair of spaced toothed plates.

19. A treestand, comprising:
a frame including a bottom portion, a front portion and a rear portion, the front portion configured for attachment to one side of a tree, the frame further including side portions spaced above the bottom portion define an occupancy envelope within the frame;
a platform assembly attached to said frame, the platform assembly comprising;
a front platform segment non-movably attached to the bottom portion of said frame; and
a rear platform segment pivotally attached to another portion of said frame and being selectively pivotable between a down position wherein the rear platform segment is co-planar with the front platform segment and an up position and wherein said treestand further comprises:
a ladder assembly attached to said frame such that an occupant may enter the occupancy envelope from the ladder assembly through an opening in the bottom portion of the frame that corresponds to the rear platform segment;
a front seat pivotally attached to the front portion of the frame above the platform assembly and configured to support the occupant while facing away from the tree, the first seat including a V-shaped notch therein; and
a rear seat pivotally coupled to the rear portion of the frame above the platform assembly, the rear seat spaced from said front seat on said one side of the tree and configured to support the occupant while facing the tree.

20. A treestand, comprising:
a platform;
a frame including an upstanding front portion attached to the platform and configured for attachment to one side of a tree, the frame further including an upstanding rear portion attached to the platform and side portions attached to the front and rear portions and being spaced above the platform to define an occupancy envelope within the frame, the rear portion further defining an entry opening into the occupancy envelope;
a ladder assembly attached to the frame to permit entry onto the platform from the ladder assembly through the entry opening;
a front seat pivotally attached to the front portion of the frame above the platform and configured to support an occupant while facing away from the tree; and
a rear seat movable between a first occupant supporting position such that when seated thereon, the occupant faces the tree and a second blocking position wherein the rear seat blocks at least a portion of said entry opening.

21. A treestand, comprising:
a frame having a front portion and a rear portion, the front portion configured for attachment to one side of a tree,
a platform assembly attached to said frame;
a ladder assembly attachable to the frame; and
a seat pivotally attachable to said frame in a first occupant position adjacent said front portion wherein an occupant seated thereon faces away from said tree, the seat being pivotally attachable to said frame in a second occupant supporting position adjacent said rear portion of said frame wherein, when the occupant is seated on the seat in the second occupant supporting position, the occupant faces the tree.
